(19) United States
(12) Patent Application Publication
(10) Pub. No.: US 2016/0169249 A1
(43) Pub. Date: Jun. 16, 2016

(54) BLOWER APPARATUS

(71) Applicant: MAKITA CORPORATION, Aichi (JP)

(72) Inventors: Makoto TAKAHASHI, Aichi (JP); Akira OJIMA, Aichi (JP)

(73) Assignee: MAKITA CORPORATION, Aichi (JP)

(21) Appl. No.: 14/950,405

(22) Filed: Nov. 24, 2015

(30) Foreign Application Priority Data
Dec. 16, 2014 (JP) 2014-254418

(51) Int. Cl. F04D 29/66; H02K 11/00; F04D 29/52; F04D 25/06; F04D 29/32; F04D 29/38; H02K 7/14; F04D 19/00

(52) U.S. Cl. CPC F04D 29/663; H02K 7/14; H02K 11/0094; F04D 19/002; F04D 25/0673; F04D 29/325; F04D 29/38; F04D 29/522

(57) ABSTRACT

A blower apparatus of the type which comprises a body housing with air inlet and outlet ends, a cylindrical motor casing assembled within the body housing in such a manner as to permit therethrough airflow introduced into the air inlet end of the body housing and exhausted outwardly from the air outlet end of the body housing, an electric motor mounted within the motor housing, an axial-flow fan having a plurality of fan blades attached on a rotary drive shaft driven by the electric motor, wherein the number Z of fan blades of the axial-flow fan and the rated rotation speed n (r/s) of the rotary drive shaft under maximum power in normal operation of the blower apparatus are determined to satisfy the following correlation

Z·n≦2000 (provided, n>160).

### BACKGROUND OF THE INVENTION

1. Field of the Invention

The present invention relates to a blower apparatus used for clearing or removing debris such as leaves and grass cuttings from a variety of work surfaces.

2. Discussion of Prior Art

Disclosed in Japanese Patent Laid-open Publication 2014-036939 is a blower apparatus of the type which comprises a body housing with air inlet and outlet ends, a cylindrical motor casing assembled within the body housing in such a manner as to permit therethrough the flow of air introduced into the air inlet end and exhausted outwardly from the air outlet end, an electric motor mounted within the motor casing, and an axial-flow fan having a hub fixed to an output shaft of the motor and a plurality of fan blades attached on the hub. In use of the blower apparatus, rotation of the axial-flow fan driven by operation of the motor causes the flow of air introduced into the air inlet end of the body housing and exhausted from a nozzle coupled with the outlet end toward the ground.

Under technical developments in recent years, an electric motor of high output performance (e.g. 21000 rpm (350 r/s) is adapted to use in a blower apparatus of the type described above. When compared with an electric motor of low output performance (e.g. 9000 rpm (150 r/s) used in a conventional blower apparatus, the electric motor of high output performance is effective to increase the volume and velocity of air flow ejected from the nozzle coupled with the outlet end of the body housing, thereby to enhance operability of the blower apparatus. In use of the blower apparatus with the electric motor of high output performance, however, high speed rotation of the axial-flow fan causes noise pollution such as high frequency noise (e.g. 2000 Hz˜8000 Hz) unpleasant for the operator's ear in cleaning operation for a long period of time.

It is, therefore, an object to provide a blower apparatus with an electric motor of high output performance capable of restraining the occurrence of high frequency noise unpleasant for the operator's ear in high speed rotation of the axial-flow fan.

To solve the problem, it has been found that the feel of sound hearing in high speed rotation of the axial-flow fan is influenced by correlation with blade passing frequency calculated from the product of the number of fan blades attached on the hub of an axial-flow fan and the rotation frequency of an electric motor. Accordingly, the present invention is directed to provide a blower apparatus which comprises a body housing with air inlet and outlet ends, a cylindrical motor casing assembled within the body housing in such a manner as to permit therethrough airflow introduced into the air inlet end of the body housing and exhausted outwardly from the air outlet end of the body housing, an electric motor mounted within the motor housing, an axial-flow fan having a plurality of fan blades attached on a rotary drive shaft driven by the electric motor, wherein the number Z of fan blades of the axial-flow fan and the rated rotation speed n (r/s) of the rotary drive shaft under maximum power in normal operation of the blower apparatus are determined to satisfy a correlation of Z·n≦2000 (provided, n>160).

As in the blower apparatus, the number Z of fan blade of the axial-flow fan and the rated rotation speed n (r/s) of the rotary drive shaft under maximum power in normal operation of the blower apparatus are determined to satisfy a correlation of Z·n≦2000 (provided, n>160), it is able to reduce blade passing frequency of sound occurring in rotation of the axial-flow fan less than 2000 Hz wherein the axial-flow fan is driven by high speed rotation (higher than 160 rpm) of the electric motor replaced with a conventional electric motor of low output performance (less than 160 rpm). Thus, in use of the blower apparatus, the operator can continue cleaning work for a long period of time without suffering from unpleasant noise higher than 2000 Hz.

### BRIEF DESCRIPTION OF THE DRAWINGS

In the drawings;

FIG. 1 is a perspective view of a blower apparatus in a preferred embodiment of the present invention;

FIG. 2 is a vertical sectional view taken along a fore-and-aft direction of the blower apparatus shown in FIG. 1;

FIG. 3 is an enlarged sectional view of a body housing of the blower apparatus shown in FIG. 2;

FIG. 4 (a) is a front view of an axial-flow fan viewed from an axial direction;

FIG. 4(b) is a side view of the axial-flow fan viewed from a direction across the axial direction; and

FIG. 5 is a table indicative of an blade passing frequency of sound caused by the number of fan blades and a rated rotation speed of an electric motor in maximum power of the blower apparatus.

### PREFERRED EMBODIMENT OF THE INVENTION

Hereinafter, a preferred embodiment of a blower apparatus in accordance with the present invention will be described with reference to the accompanying drawings. The blow apparatus 10 is used for cleaning work to remove debris such as leaves and grass cuttings from a variety of work surfaces. Formed in a lower portion of the interior of a body housing 11 is an airflow passage 12 extending in a fore-and-aft direction. The body housing 11 is provided at its rear end with an air inlet opening 12a of the airflow passage 12 and at its front end with an air outlet opening 12b of the airflow passage 12. The air inlet opening 12a is enclosed with a meshed cover 13, while the air outlet opening 12b is coupled with a nozzle duct 14 for exhausting the air toward the ground at the front end of body housing 11.

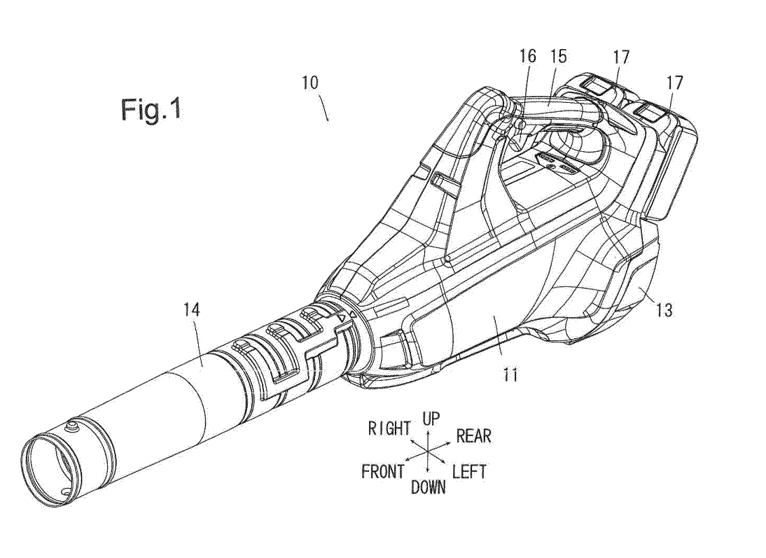

As shown in FIGS. 1˜3, a grip handle 15 is integrally provided with the upper portion of body housing 11 to be grasped by a user's hand. The grip handle 15 is provided at its lower surface with a trigger switch 16 to be operated by an operator for activating an electric motor 25 described later. A pair of rechargeable battery packs or power packs 17, 17 is detachably mounted on the rear portion of body housing 11 to be used as a source of electric power of the electric motor 25. A control circuit 18 for the electric motor 25 is provided on an upper portion of body housing 11.

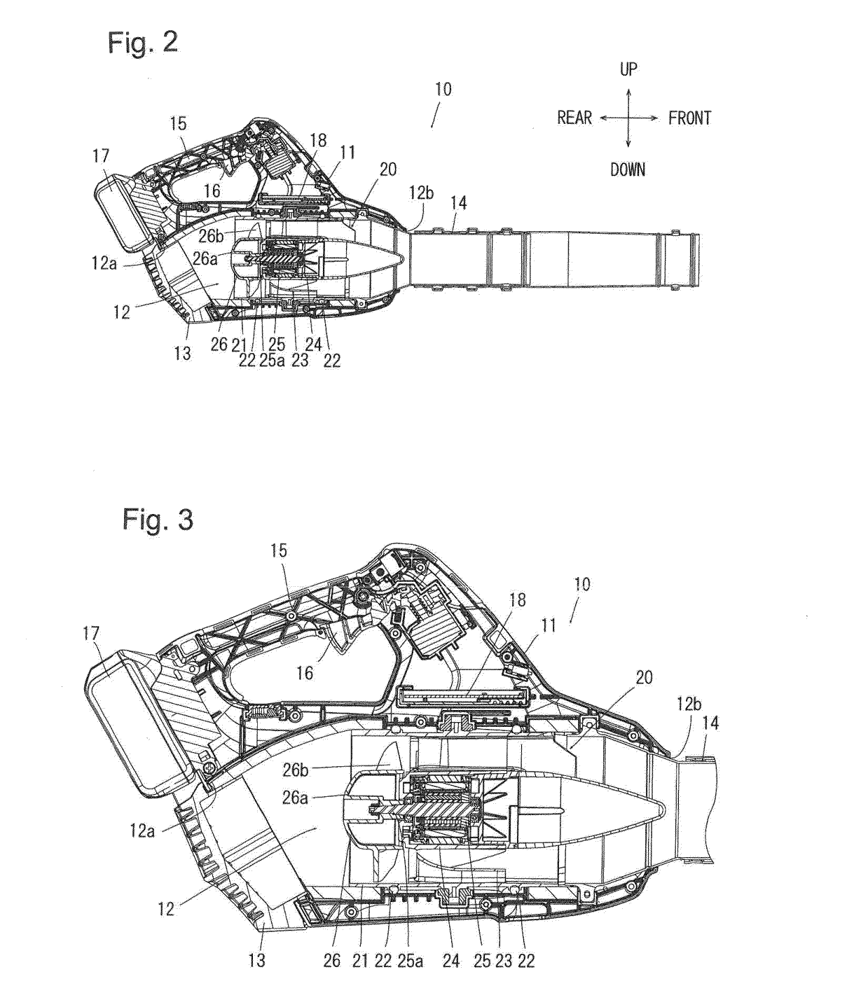

As shown FIGS. 2 and 3, a motor casing 20 is coaxially assembled within the body housing 11 at an approximate central portion of the airflow passage 12 in the axial direction. The motor casing 20 has a cylindrical outer wall portion 21 which is supported in place on an internal wall surface of body housing 11 through vibration isolating rings 22 of elastic material such as rubber material.

As shown in FIG. 3, the cylindrical outer wall portion 21 is provided at its inner surface with a plurality of stator blades 23 extending radially inward. A cylindrical inner wall portion 24 is coaxially supported in place by means of stator blades 23. The electric motor 25 is mounted within the cylindrical inner wall portion 24. In this embodiment, the rated speed of the output drive shaft 25a of electric motor 25 is defined to be 367 (r/s) (22000 rpm) in maximum output power in normal operation. The electric motor is in the form of a brush-less DC electric motor of the inner rotor type. The inner rotor of permanent magnet is rotated by power supply to the inside windings of a stator. In the electric motor 25, the supply of power to the inside windings from the battery packs 17, 17 is regulated by a control signal applied from the control circuit 18, and the inner rotor is driven in accordance with variation of the magnetic field under control of the power supply to the inside windings

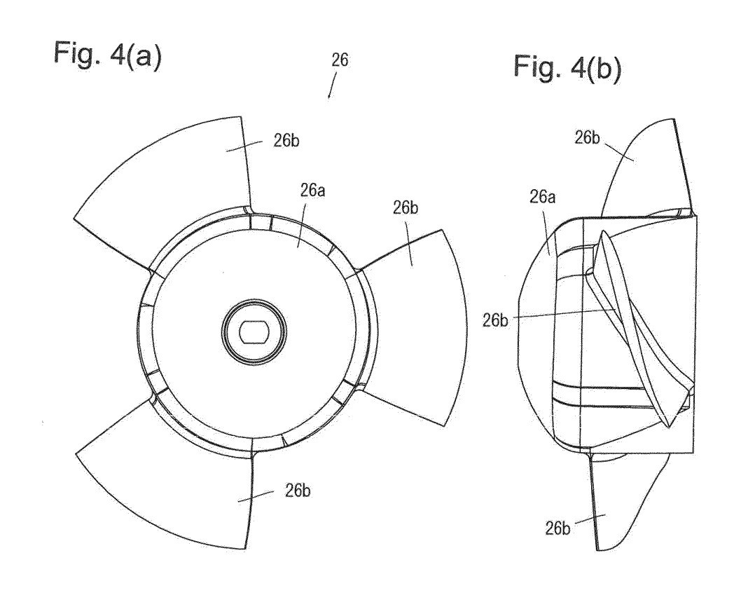

The output drive shaft 25a fixed to the inner rotor of electric motor 25 projects rearward from the cylindrical inner wall portion 24, and the hub 26a of axial-flow fan 26 is mounted to the output drive shaft 25a. As shown in FIG. 4, the axial-flow fan 26 is comprised of three fan blades 26b (dynamic fan blade) extending radially outward from the hub 26a at circumferentially equally spaced positions. The outer diameter of axial-flow fan 26 perpendicularly across the drive shaft is smaller than the axial length of motor casing 20. Airflow caused by rotation of the axial-flow fan 26 driven by the motor 25 is introduced into the airflow passage 12 from the rear end air inlet opening 12a and exhausted forward from the front end air outlet opening 12b.

In use of the blow apparatus, the trigger switch 16 is operated by a finger of the operator's hand gasped the grip handle 15 such that the electric motor 25 is activated by supply of power from the battery packs 17 to rotate the axial-flow fan 26. Thus, airflow caused by rotation of the axial-flow fan 26 is introduced into the airflow passage 12 from the rear end inlet opening and exhausted from the nozzle duct 12b coupled with the front end outlet opening 12 toward the ground to remove debris such as fallen leaves, grass cuttings for cleaning various surfaces of the ground.

In operation of the blower apparatus, it has been found that the feel of sound hearing in high speed rotation of the axial-flow fan 26 is influenced by correlation with blade passing frequency calculated from the product of the number Z of fan blades 26b of the axial-flow fan 26 and the rotation speed of the output drive shaft of the motor. Based on such recognition, the number Z of fan blades of the axial-flow fan and the rated rotation speed n (r/s) of the output drive shaft under maximum power in normal operation of the blower apparatus is intentionally determined to satisfy the following correlation.

Z·n≦2000 (provided, n>160)

In this embodiment, the rated rotation speed n (r/s) of the motor 25 under maximum power in normal operation is determined to be 367 (r/s) (22000 rpm), and the axial-flow fan 26 is provided with the three fan blades so that the frequency of sound caused by high speed rotation does not increase more than 2000 Hz unpleasant feel for the operator's ear. This is effective to restrain the frequency of sound caused by high speed rotation of the axial-flow fan 26 to 1101 Hz. Thus, even if the axial-flow fan was rotated by the maximum power of the motor in use of the blower apparatus 10, the operator would not be suffered from unpleasant sound caused by high speed rotation of the axial-flow fan 26.

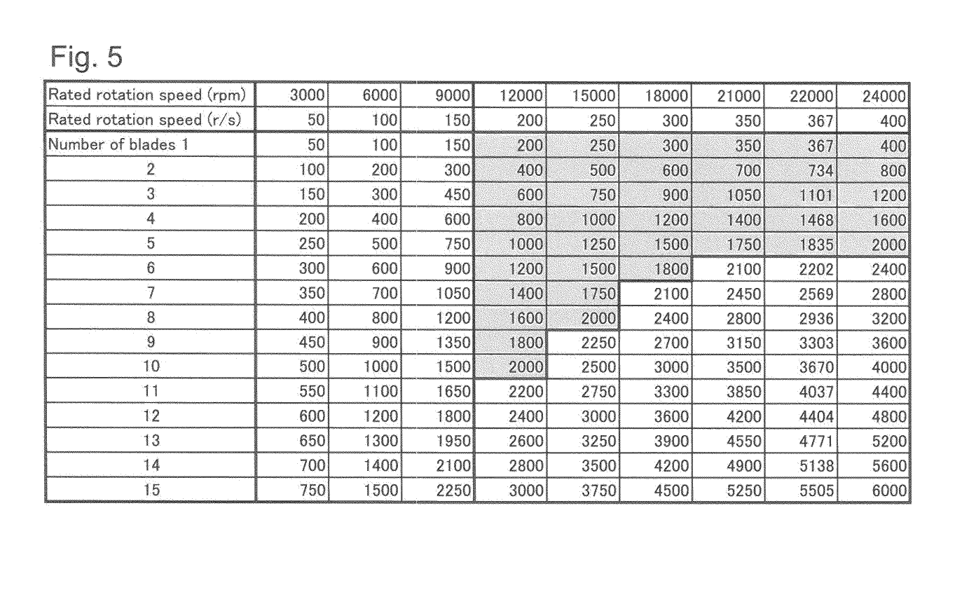

In a practical embodiment of the present invention, another high speed electric motor may be replaced with the electric motor 25 in the blow apparatus. In such use of the high speed electric motor, it is preferable that the rated rotation speed n (r/s) of the replaced electric motor under maximum power in normal operation is determined more than 160 (r/s)(9600 rpm). In use of the motor, it is also preferable that number of fan blades is determined as listed on a table of FIG. 5 in accordance with the rated rotation speed. With such arrangement of the number of fan blades, the blade passing frequency of sound caused by high speed rotation of the axial-flow fan can be restrained less than 2000 Hz as follows.

In the case that the rated rotation speed of the electric motor is 200 (r/s)(12000 rpm), the number of fan blades of the axial-flow fan is determined less than 10 blades. In the case that the rated rotation speed of the electric motor is 250 (r/s)(15000 rpm), the number of blades is determined less than 8 blades. In the case that the rated rotation speed of the electric motor is 300 (r/s)(18000 rpm), the number of fan blades is determined less than 6 blades. In the case that the rated rotation speed of the electric motor is 350 (r/s)(21000 rpm), the number of fan blades is determined less than 5 blades. In the case that the rated rotation speed of the electric motor is 367 (r/s)(22000 rpm), the number of fan blades is determined less than 5 blades. In the case that the rated rotation speed of the electric motor is 400 (r/s)(24000 rpm), the number of fan blades is determined less than 5 blades.

In a practical embodiment of the present invention, the blower apparatus may be designed as a dust collector of the type which includes a body housing with air inlet and outlet ends, a motor casing assembled within the body housing in such a manner as to permit therethrough the flow of air introduced into the air inlet end and exhausted from the air outlet end, an electric motor mounted within the motor casing, an axial-flow fan having a hub fixed to an output drive shaft driven by the electric motor and a plurality of fan blades attached on the hub. In use of the dust collector, rotation of the axial-flow fan driven by the electric motor causes airflow sucking dust or debris on the ground into a nozzle coupled with the air inlet end at the front of the body housing to be collected in a dust bag coupled with the air outlet end at the rear of the body housing. In the dust collector, the correlation of the rated rotation speed of the electric motor under the maximum power in normal operation and the number of the fan blades of the axial-flow fan is substantially the same as in the blower apparatus.

Although in the foregoing embodiment, the battery packs are used for supply of electric power to the electric motor, an external source of electric power may be connected to the electric motor by means of a cord.

What is claimed is:

1. A blower apparatus of the type comprising a body housing with air inlet and outlet ends, a cylindrical motor casing assembled within the body housing in such a manner as to permit therethrough airflow introduced into the air inlet end of the body housing and exhausted outwardly from the air outlet end of the body housing, an electric motor mounted within the motor housing, an axial-flow fan having a plurality of fan blades attached on an output drive shaft driven by the electric motor,
wherein the number Z of fan blades of the axial-flow fan and the rated rotation speed n (r/s) of the rotary drive shaft under maximum power in normal operation of the blower apparatus are determined to satisfy the following correlation
Z·n≦2000 (provided, n>160).

2. A blower apparatus as claimed in claim 1, wherein said electric motor is a brush-less DC electric motor, and wherein a rechargeable battery pack is detachably mounted on a rear portion of said body housing for supply of electric power to the electric motor.

3. A blower apparatus as claimed in claim 2, wherein said electric motor is activated under control of a signal applied from a rotation control circuit provided on an upper portion of said body housing.

4. A blower apparatus as claimed in claim 1, wherein said axial-flow fan has three fan blades, and the rated rotation speed n (r/s) is defined to be 367 (r/s)(22000 rpm).
